(19) United States
(12) Patent Application Publication
(10) Pub. No.: US 2024/0388075 A1
(43) Pub. Date: Nov. 21, 2024

(54) WIRING BOARD

(71) Applicant: YAZAKI CORPORATION, Tokyo (JP)

(72) Inventors: Hideaki Kikuchi, Susono-shi (JP); Hiroyuki Ogura, Susono-shi (JP)

(21) Appl. No.: 18/644,100

(22) Filed: Apr. 24, 2024

(30) Foreign Application Priority Data
May 19, 2023 (JP) 2023-083242

(51) Int. Cl. H02G 3/30; B60R 16/02

(52) U.S. Cl. CPC H02G 3/30; B60R 16/0207

(57) ABSTRACT

A wiring board includes: a panel attached to a vehicle body and partitioning a vehicle interior and a front compartment of the vehicle body; a printed circuit body printed on the panel; and a wire harness attached to the panel. The wiring board facilitates the assembly work of the wiring to the vicinity of the instrument panel.

### CROSS-REFERENCE TO RELATED APPLICATION(S)

This application is based upon and claims the benefit of priority from prior Japanese patent application No. 2023-083242 filed on May 19, 2023, the entire contents of which are incorporated herein by reference.

### BACKGROUND

### 1. Field of the Invention

The present disclosure relates to a wiring board.

### 2. Description of the Related Art

Various electronic devices are mounted on an instrument panel in front of a driver's seat and a passenger's seat in a vehicle interior. Therefore, it is necessary to provide a wire harness (wiring) to be connected to the electronic device around the instrument panel. Further, the instrument panel is provided with a reinforcing member called a “reinforcement” extending in a left-right direction. In the related art, a wire harness to be connected to an electronic device is supported by a reinforcement (JP2019-119287A). Specifically, in the wire harness, a trunk line extending in the left-right direction is supported by the reinforcement, and branch lines branching from the trunk line extend downward and are connected to the electronic device.

However, since the wire harness provided with the plurality of branch lines has a complicated shape, it is necessary to manually assemble the wire harness to a vehicle, and there is a problem that assembly work becomes complicated.

### SUMMARY

The present disclosure has been made in view of the above circumstances, and an object thereof is to provide a wiring board that facilitates assembly work of wiring to the vicinity of an instrument panel.

In order to achieve the above object, a wiring board according to the present disclosure has the following features. Specifically, according to an aspect of the present disclosure, there is provided a wiring board including: a panel attached to a vehicle body and partitioning a vehicle interior and a front compartment of the vehicle body; a printed circuit body printed on the panel; and a wire harness attached to the panel.

According to the present disclosure, it is possible to provide the wiring board that facilitates the assembly work of the wiring to the vicinity of the instrument panel.

The present disclosure has been briefly described above. Further, details of the present disclosure can be clarified by reading modes (hereinafter, referred to as “embodiments”) for carrying out the disclosure described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a configuration diagram showing a wiring board according to an embodiment of the present disclosure;

FIG. 2 is a cross-sectional view showing an example of electric wires shown in FIG. 1;

FIG. 3 is a cross-sectional view showing an example of the electric wires shown in FIG. 1;

FIG. 4 is a cross-sectional view showing an example of the electric wires shown in FIG. 1; and

FIG. 5 is a cross-sectional view showing an example of the electric wires shown in FIG. 1.

### DETAILED DESCRIPTION OF THE INVENTION

Specific embodiments of the present disclosure will be described below with reference to the drawings.

### First Embodiment

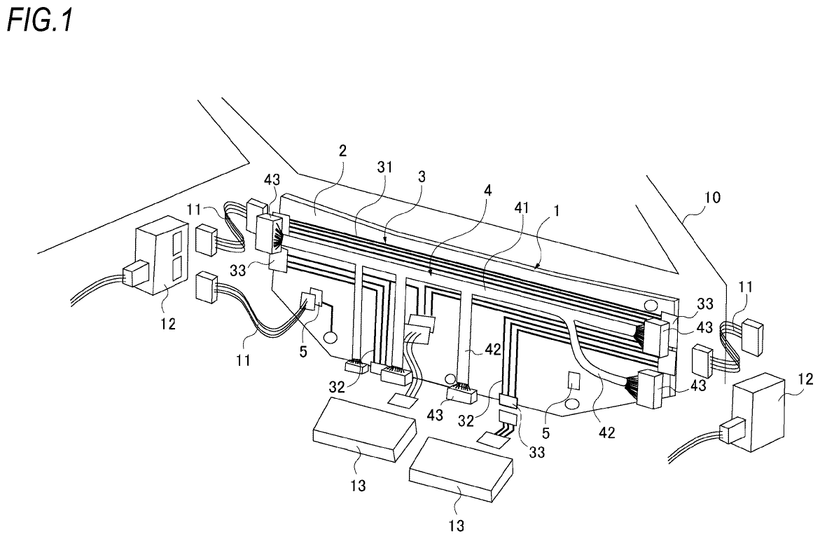

A wiring board 1 of a first embodiment will be described with reference to FIG. 1. As shown in FIG. 1, a wiring board 1 is attached to a vehicle body 10 made of metal, and includes a panel 2 that partitions a vehicle interior in the vehicle body 10 and a front compartment provided in front of the vehicle interior, a printed circuit body 3 printed on the panel 2, a wire harness 4 attached to the panel, and through connectors 5.

Next, the vehicle body 10 to which the above-described wiring board 1 is attached will be described. The vehicle body 10 to which the wiring board 1 of the present embodiment is attached is formed by casting with a large mold.

The vehicle body 10 formed by casting with the large mold has high strength. Therefore, a partition wall between the vehicle interior and the front compartment does not need to have strength enough to maintain a shape of the vehicle body. Accordingly, the vehicle body and the partition wall do not need to be integrally formed, and a separate partition wall can be adopted.

In addition, in the case of an electric automobile on which no engine is mounted, no internal combustion engine is present, a high temperature is hardly generated, and noise is small. For this reason, not only metal but also a resin can be adopted as the partition wall in the vehicle body 10.

For the reasons described above, in the present embodiment, the wiring board 1 that is attached to the vehicle body 10, formed by casting, of the electric automobile on which no engine is mounted and that adopts the resin panel 2 as the partition wall is exemplified.

A vehicle interior in which a driver's seat, a front passenger's seat, and a rear seat are disposed, and a front compartment provided in front of the vehicle interior are formed in the vehicle body 10. In the vehicle body 10, there is no partition wall between the vehicle interior and the front compartment, and an opening is provided. The resin panel 2 is formed in a shape that closes the opening between the vehicle interior and the front compartment.

The printed circuit body 3 is printed on a surface on a vehicle interior side of the resin panel 2. In the present embodiment, an example in which the printed circuit body 3 is provided only on the surface on the vehicle interior side of the resin panel 2 will be described, but the present disclosure is not limited thereto, and the printed circuit body 3 may be printed on both surfaces of the resin panel 2 or may have a multilayer structure.

In the present embodiment, the printed circuit body 3 includes a plurality of pieces of first wiring 31 extending in a left-right direction and a plurality of pieces of second wiring 32 extending downward from the pieces of first wiring 31. Connectors 33 for surface mounting are attached to terminals of the pieces of first wiring 31 and disposed on both left and right edge portions of the resin panel 2. Connectors 33 are also attached to terminals of the pieces of second wiring 32 and disposed on an edge portion of the resin panel 2 (a lower edge portion of the resin panel 2 in the present embodiment).

The wire harness 4 is attached to the surface on the vehicle interior side of the resin panel 2. In the present embodiment, an example in which the wire harness 4 is attached only to the surface on the vehicle interior side of the resin panel 2 will be described, but the present disclosure is not limited thereto, and the wire harness 4 may be attached to a surface on a front compartment side. In the present embodiment, the wire harness 4 includes a trunk line 41 extending in the left-right direction and branch lines 42 branching from the trunk line 41 and extending downward. Connectors 43 are attached to terminals of the trunk line 41 and disposed on both left and right edge portions of the resin panel 2. The connector 43 is also attached to a terminal of the branch line 42 and the connectors 43 are disposed on edge portions (the lower end portion and a right end portion in the present embodiment) of the resin panel 2.

The connectors 33 and 43 are connected to a junction box 12 and a terminal device 13 via a relay harness 11 or directly.

The through connector 5 is fitted into a through hole provided in the resin panel 2, and connector portions are provided on both the vehicle interior side and the front compartment side of the resin panel 2. Accordingly, a device on the vehicle interior side and a device on the front compartment side can be connected via the through connector 5. In the example shown in FIG. 1, the connector portion on the vehicle interior side of the through connector 5 is connected to the junction box 12 via the relay harness 11. The junction box 12 disposed in the vehicle interior is connected to a device disposed in the front compartment via the through connector 5.

As shown in FIG. 1, the above-described wire harness 4 may be attached onto the resin panel 2 from above the printed circuit body 3. Further, the wire harness 4 may be attached onto the resin panel 2 on which the printed circuit body 3 is not printed. For example, since it is difficult to form the printed circuit body 3 in a portion where a shape of the resin panel 2 is uneven, the wire harness 4 may be attached to a portion where the resin panel 2 is uneven, and the printed circuit body 3 may be formed in a flat portion.

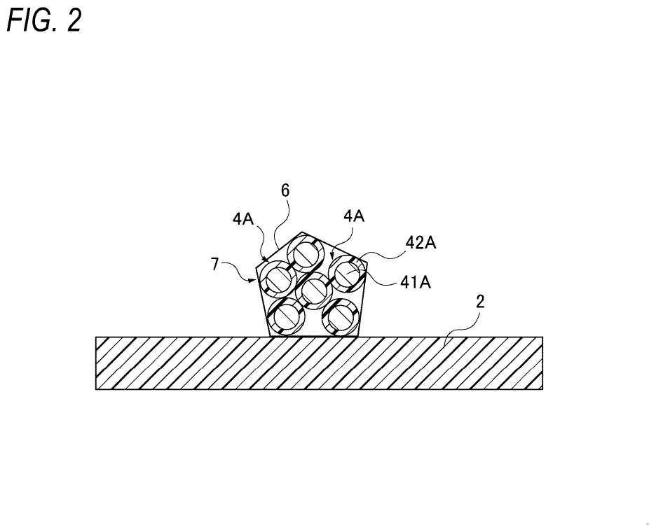

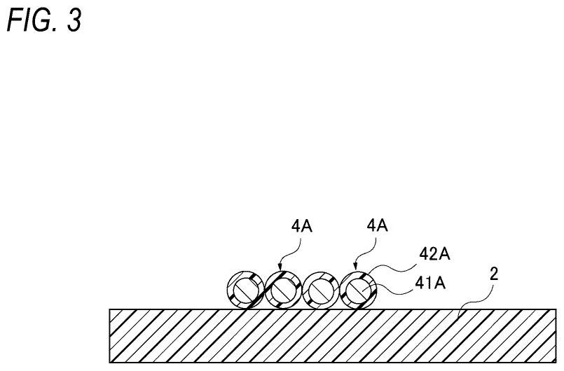

As shown in FIGS. 2 and 3, the wire harness 4 may include general electric wires 4A each having a circular cross section. The general electric wire 4A includes at least a core wire 41A having a circular cross section and a covering portion 42A covering the core wire 41A one by one. As shown in FIG. 2, the plurality of general electric wires 4A may be bundled by a bundling member 6 such as a tape or a bundling band to form a group of electric wires 7. The group of electric wires 7 is attached to the resin panel 2 using a harness clip (not shown) or the like. As shown in FIG. 3, a plurality of general electric wires 4A may be disposed on the resin panel 2 and fixed with an adhesive or the like.

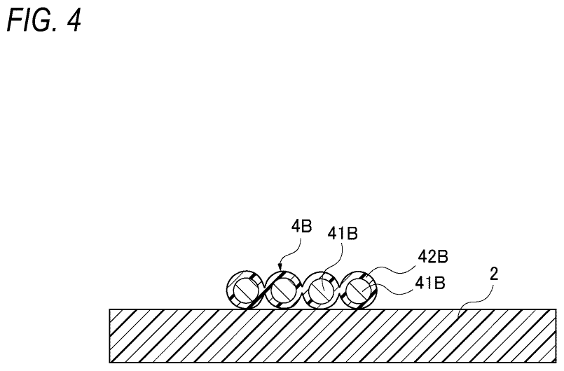

Further, as shown in FIG. 4, the wire harness 4 may be formed of, as a flat circuit body, a flat cable (FC) 4B having a flat cross section. The FC 4B includes a plurality of core wires 41B each having a circular cross section and a covering portion 42B that collectively covers the plurality of core wires 41B in one direction, and is flat as a whole in an arrangement direction of the core wires 41B. The FC 4B can be disposed on the resin panel 2 such that a thickness direction thereof is along a thickness direction of the resin panel 2, and can be fixed by an adhesive or the like.

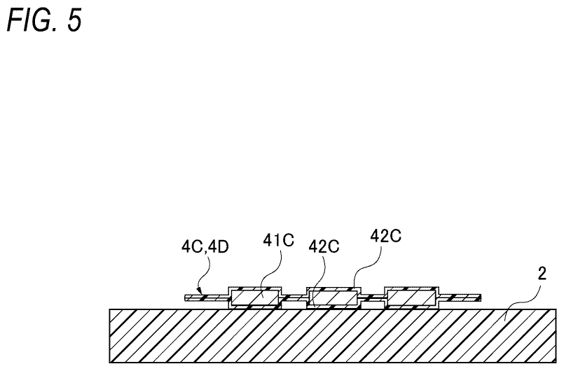

As shown in FIG. 5, the wire harness 4 may be formed of, as flat circuit bodies, a flexible printed circuit (FPC) 4C and a flexible flat cable (FFC) 4D having a flat cross section. The FPC 4C and the FFC 4D include a plurality of core wires 41C each having a rectangular cross section and a pair of insulating sheets 42C sandwiching both sides in a thickness direction of the plurality of core wires 41C in a state where the plurality of core wires 41C are arranged in the width direction, and are flat as a whole in an arrangement direction of the core wires 41C.

The FPC 4C and the FFC 4D can be arranged on the resin panel 2 such that the thickness direction of the FPC 4C and the FFC 4D is along the thickness direction of the resin panel 2, and can be fixed by an adhesive or the like.

According to the above-described embodiment, the printed circuit body 3 and the wire harness 4 can be assembled in the vicinity of the instrument panel only by attaching the resin panel 2 on which the printed circuit body 3 is printed and to which the wire harness 4 is attached between the vehicle interior and the front compartment. Accordingly, assembly work of the printed circuit body 3 and the wire harness 4 to the vicinity of the instrument panel is easily performed.

The printed circuit body 3 has a lower conductivity than the wire harness 4. In the present embodiment, a small current circuit through which a small current flows is formed by the printed circuit body 3, and a large current circuit through which a large current flows is formed by the wire harness 4 (the general electric wires 4A, the group of electric wires 7, the FC 4B, the FPC 4C, and the FFC 4D). That is, the current flowing through the printed circuit body 3 can be made smaller than the current flowing through the wire harness 4. Accordingly, circuit formation efficiency can be improved.

### Second Embodiment

Next, the wiring board 1 of a second embodiment will be described. Similar to the first embodiment, the wiring board 1 of the second embodiment includes the resin panel 2, the printed circuit body 3, the wire harness 4, and the through connectors 5. In the second embodiment, the wire harness 4 includes a special circuit body, and the printed circuit body 3 does not include the special circuit body.

The special circuit body is, for example, an electric wire including a core wire, a covering portion covering the core wire, an outer conductor covering the covering portion, and an outer covering portion covering the outer conductor, such as a shielded electric wire; an electric wire including a core wire, an inner insulator provided on an outer periphery of the core wire, an outer conductor covering the inner insulator, and an outer covering portion covering the outer conductor, such as a coaxial cable; and a twisted electric wire formed by twisting the plurality of general electric wires 4A. Since it is difficult to form the special circuit body in the printed circuit body 3, the special circuit body is handled by the wire harness 4, and thus the wiring (the printed circuit body 3 and the wire harness 4) is easily routed on the resin panel 2.

The wire harness 4 may include not only the special circuit body but also both the special circuit body and the general electric wires 4A.

The wire harness 4 includes not only the special circuit body and the general electric wires 4A, and may appropriately use the plurality of types of flat circuit bodies (FC 4B, FPC 4C, and FFC 4D). In this case, the FC 4B, the FPC 4C, and the FFC 4D (flat circuit bodies) do not include the special circuit body since it is difficult to form the special circuit body therein, and the printed circuit body 3 also does not include the special circuit body. By combining the special circuit body, the general electric wires 4A, the flat circuit bodies, and the printed circuit body 3, the wiring on the resin panel 2 can be routed thinner than in the case where the flat circuit body is not used.

### Third Embodiment

Next, the wiring board 1 of a third embodiment will be described. Similar to the first embodiment, the wiring board 1 of the third embodiment includes the resin panel 2, the printed circuit body 3, the wire harness 4, and the through connectors 5. In the third embodiment, the wire harness 4 is connected to a standard device of a vehicle, and the printed circuit body 3 is connected to an optional device of the vehicle. The vehicle is provided with the standard device mounted on any vehicle as long as it is a vehicle of the same type, and the optional device selectively mounted depending on specifications.

According to the third embodiment, an optional circuit connected to the optional device different depending on the specifications is formed by the printed circuit body 3. Accordingly, the same wire harness 4 may be attached to the resin panel 2 on which the printed circuit body 3 is printed even in a vehicle on which a different optional device are mounted. It is not necessary to attach the wire harness 4 different for each specification to the resin panel 2, and manufacturing processing is simplified. Further, the printed circuit body 3 can change data of a printing machine and automatically print on the resin panel 2 by the printing machine. Therefore, by connecting the printed circuit body 3 to the optional device, a probability of printing an erroneous optional circuit (that is, a probability of occurrence of a human error) can be reduced.

### Fourth Embodiment

Next, the wiring board 1 of a fourth embodiment will be described. Similar to the first embodiment, the wiring board 1 of the fourth embodiment includes the resin panel 2, the printed circuit body 3, the wire harness 4, and the through connectors 5. In the fourth embodiment, contrary to the third embodiment, the wire harness 4 is connected to an optional device of a vehicle, and the printed circuit body 3 is connected to a standard device of the vehicle. According to the fourth embodiment, an optional circuit connected to the optional

device different depending on specifications is formed by the wire harness 4. Accordingly, the wire harness 4 may be attached to the resin panel 2 on which the same printed circuit body 3 is printed even in a vehicle on which different optional devices are mounted. It is not necessary to prepare the resin panel 2 on which the printed circuit body 3 different for each specification is printed, and the cost for forming the printed circuit body 3 can be reduced. Further, a probability of printing an erroneous standard circuit (that is, a probability of occurrence of a human error) can be reduced.

The present disclosure is not limited to the embodiment described above and can be appropriately modified, improved and the like. In addition, materials, shapes, sizes, numbers, arrangement positions and the like of components in the embodiment described above are freely selected and are not limited as long as the present disclosure can be implemented.

For example, a material of the panel 2 that partitions the vehicle interior and the front compartment is not limited to a resin, and may be metal or carbon.

According to the embodiments described above, the through connector 5 is disposed on the resin panel 2, but the through connector 5 is not essential and may be omitted.

According to the embodiments described above, the vehicle body 10 is formed by casting, but the vehicle body 10 is not limited to being formed by casting as long as the panel 2 can be adopted. For example, the vehicle body may be formed by forging.

According to the embodiments described above, the vehicle body 10 to which the wiring board 1 is attached is a vehicle body of the electric automobile, but the present disclosure is not limited thereto. The vehicle body 10 of an automobile mounted on an engine may be used.

Here, features of the embodiment of the wiring board according to the present disclosure described above are briefly summarized and listed in the following [1] to [5].

[1] A wiring board (1) includes:

a panel (2), configured to be attached to a vehicle body (10), and partitioning a vehicle interior and a front compartment of the vehicle body (10);

a printed circuit body (3) printed on the panel (2); and

a wire harness (4) attached to the panel (2).

According to the configuration of the above [1], the printed circuit body (3) and the wire harness (4) can be assembled in the vicinity of the instrument panel only by attaching the panel (2) on which the printed circuit body (3) is printed and to which the wire harness (4) is attached between the vehicle interior and the front compartment. Accordingly, assembly work of the printed circuit body (3) and the wire harness (4) to the vicinity of the instrument panel is easily performed.

[2] The wiring board (1) according to the above [1], in which:

a small current circuit through which a small current flows is formed by the printed circuit body (3); and

a large current circuit through which a large current flows is formed by the wire harness (4).

According to the configuration of the above [2], since the printed circuit body (3) has a lower conductivity than the wire harness (4), circuit formation efficiency can be improved by forming the small current circuit with the printed circuit body (3) and forming the large current circuit with the wire harness (4).

[3] The wiring board (1) according to the above [1], in which:

the wire harness (4) includes a special circuit body; and
the printed circuit body (3) does not include the special circuit body.

According to the configuration of the above [3], since it is difficult to form the special circuit body in the printed circuit body (3), the special circuit body is handled by the wire harness (4), and thus wiring is easily routed on the panel (2).

[4] The wiring board (1) according to the above [1], in which:

the wire harness (4) is connected to a standard device of a vehicle; and
the printed circuit body (3) is connected to an optional device of the vehicle. According to the configuration of the above [4], it is not necessary to attach the wire

harness (4) different for each specification to the panel (2), and manufacturing process is simplified. A probability of printing an erroneous optional circuit (that is, a probability of occurrence of a human error) can be reduced.

[5] The wiring board (1) according to the above [1], in which:

the wire harness (4) is connected to an optional device of a vehicle; and
the printed circuit body (3) is connected to a standard device of the vehicle.

According to the configuration of the above [5], it is not necessary to prepare the panel (2) on which the printed circuit body (3) different for each specification is printed, and the cost for forming the printed circuit body (3) can be reduced. A probability of printing an erroneous standard circuit (that is, a probability of occurrence of a human error) can be reduced.

1. A wiring board comprising:
a panel, configured to be attached to a vehicle body, and partitioning a vehicle interior and a front compartment of the vehicle body;
a printed circuit body printed on the panel; and
a wire harness attached to the panel.

2. The wiring board according to claim 1, wherein:
a small current circuit through which a small current flows is formed by the printed circuit body; and
a large current circuit through which a large current flows is formed by the wire harness.

3. The wiring board according to claim 1, wherein:
the wire harness includes a special circuit body; and
the printed circuit body does not include the special circuit body.

4. The wiring board according to claim 1, wherein:
the wire harness is connected to a standard device of a vehicle; and
the printed circuit body is connected to an optional device of the vehicle.

5. The wiring board according to claim 1, wherein:
the wire harness is connected to an optional device of a vehicle; and
the printed circuit body is connected to a standard device of the vehicle.
